(19) United States
(12) Patent Application Publication
(10) Pub. No.: US 2016/0350148 A1
(43) Pub. Date: Dec. 1, 2016

(54) THIN CLIENT SYSTEM, SERVER DEVICE, POLICY MANAGEMENT DEVICE, CONTROL METHOD, AND NON-TRANSITORY COMPUTER READABLE RECORDING MEDIUM

(71) Applicant: FUJITSU LIMITED, Kawasaki-shi (JP)

(72) Inventors: Shinichi Kitagawa, Matsumoto (JP); Tsukasa Kobayashi, Shiojiri (JP)

(73) Assignee: FUJITSU LIMITED, Kawasaki-shi (JP)

(21) Appl. No.: 15/082,368

(22) Filed: Mar. 28, 2016

(30) Foreign Application Priority Data
May 26, 2015 (JP) 2015-106890

(51) Int. Cl. G06F 9/455; H04L 29/06

(52) U.S. Cl. CPC G06F 9/45558; H04L 67/42; G06F 2009/45595

(57) ABSTRACT

A thin client server, upon accepting a login request for a virtual machine using a specific user account from a thin client terminal, transmits information on the user account and address information on the thin client terminal to a policy management server. The policy management server specifies information on a policy corresponding to the received address information by referring to correspondence relation information that is stored in a storage with respect to the transmitted information on the user account and that is about information on a policy corresponding to address information, and selects a policy corresponding to the specified information on the policy as a policy to be applied to the virtual machine.

### CROSS-REFERENCE TO RELATED APPLICATION

This application is based upon and claims the benefit of priority of the prior Japanese Patent Application No. 2015-106890, filed on May 26, 2015, the entire contents of which are incorporated herein by reference.

### FIELD

The embodiments discussed herein are related to a thin client system and the like.

### BACKGROUND

There has been a thin client system, in which a user accesses a server device by using a terminal device and performs processes by using resources of the server device. In the thin client system, there are increasing cases in which a mobile terminal, such as a smartphone or a tablet terminal, is implemented as a thin client terminal.

By implementing the mobile terminal as the thin client terminal, a user is provided with an environment in which the user can access the server from various terminal devices. Consequently, the user need not necessarily perform accesses from the thin client terminal to the server by using a specific terminal device.

Patent Document 1: Japanese Laid-open Patent Publication No. 2009-301515

### SUMMARY

According to an aspect of an embodiment, a thin client system includes: a server device that provides a virtual machine to a thin client device in response to a request from the thin client device; and a policy management device that manages information on a policy to be applied to the virtual machine. The server device includes a processor that executes a process including: transmitting, upon accepting a login request for the virtual machine using a specific user account from the thin client device, information on the user account and address information on the thin client device to the policy management device, and the policy management device includes a processor that executes a process including: specifying information on a policy corresponding to the received address information by referring to correspondence relation information that is stored in a storage with respect to the transmitted information on the user account and that is about information on a policy corresponding to address information; and selecting a policy corresponding to the specified information on the policy as a policy to be applied to the virtual machine.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a functional configuration of each of devices included in a virtual machine control system according to a first embodiment;

FIG. 2 is a diagram illustrating an example of environment definition data;

FIG. 3 is a sequence diagram illustrating the flow of a login process according to the first embodiment;

FIG. 4 is a sequence diagram illustrating the flow of a policy changing process according to the first embodiment;

FIG. 5 is a flowchart illustrating the flow of a change determination process according to the first embodiment; and

FIG. 6 is a diagram illustrating a hardware configuration example of a computer that performs a virtual machine control program according to the first embodiment and a second embodiment.

### DESCRIPTION OF EMBODIMENTS

However, in the above-described technology, in some cases, security may be reduced.

Specifically, in the above-described thin client system, if the server device stores therein data that is prohibited from being taken out of an office and if the thin client terminal is located outside the office, even the data that is prohibited from being taken out can be referred to by the thin client terminal. Therefore, for example, if a file that is allowed to be accessed inside the office but is prohibited from being accessed outside the office is taken from the inside to the outside of the office while the file is loaded on a memory of the thin client terminal, there may be a case in which an access outside the office is practically allowed. Even if a policy on the security, such as access authority, of the file is set for the user, the policy is only uniformly set.

Preferred embodiments will be explained with reference to accompanying drawings. The disclosed technology is not limited by the embodiments. The embodiments may be combined appropriately as long as the processing contents do not conflict with each other.

### [a] First Embodiment

### System Configuration

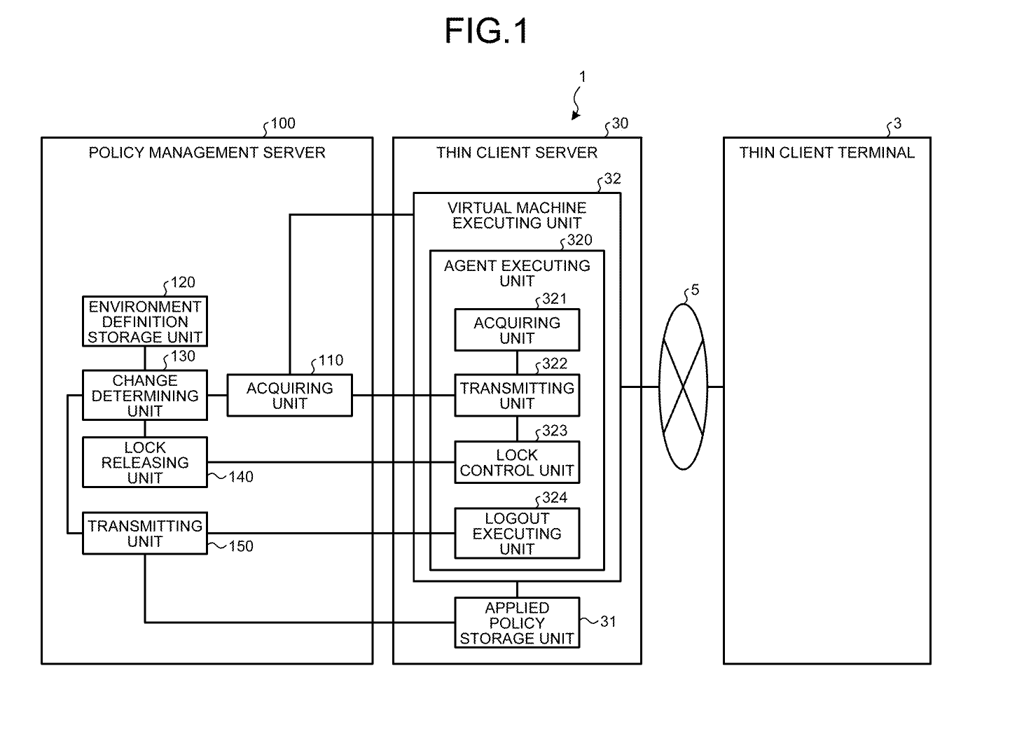

FIG. 1 is a block diagram illustrating a functional configuration of each of devices included in a virtual machine control system according to a first embodiment. As one aspect, a virtual machine control system 1 illustrated in FIG. 1 changes setting of a policy applied to a virtual computer, which is a so-called virtual machine that a thin client server 30 allows a thin client terminal 3 to use, in accordance with a change in an environment in which the thin client terminal 3 connects to the thin client server 30. The “virtual machine control system” described herein is included in a thin client system according to one embodiment.

As illustrated in FIG. 1, the virtual machine control system 1 accommodates the thin client terminal 3, the thin client server 30, and a policy management server 100. While FIG. 1 illustrates an example in which the single thin client terminal 3 is connected to the thin client server 30, it is possible to accommodate an arbitrary number of the thin client terminals 3 in the thin client server 30.

The thin client terminal 3 and the thin client server 30 are communicably connected to each other via a network 5. As the network 5, various communication networks, such as a local area network (LAN) or a virtual private network (VPN), may be used regardless of whether it is wired or wireless. As a communication protocol between the thin client terminal 3 and the thin client server 30, as one example, a remote frame buffer (RFB) protocol in virtual network computing (VNC) may be used.

The thin client terminal 3 is a computer that uses a virtual machine that operates on the thin client server 30.

As one embodiment, the thin client terminal 3 is implemented by installing an operating system (OS) for a thin client in various computers, such as desktop or notebook personal computers. The “mobile terminal” described herein includes not only a mobile communication terminal, such as a smartphone, a mobile phone, and a personal handyphone system (PHS), but also a tablet terminal, a slate terminal, and the like. As one example, the thin client terminal 3 on which the OS for a thin client operates can provide the following functions. For example, the thin client terminal 3 can accept a login request or a logoff request for a virtual machine that operates on the thin client server 30. In addition, the thin client terminal 3 sends operation information accepted via an input device (not illustrated) to the thin client server 30, or receives screen information on a virtual desktop sent from the virtual machine that operates on the thin client server 30.

The thin client server 30 is a server device that allows the thin client terminal 3 to use the virtual machine. The “thin client server” described herein corresponds to an example of an information processing apparatus.

As one embodiment, the thin client server 30 is implemented by installing a virtual OS, such as a hypervisor. Due to operation of the hypervisor on the thin client server 30, the thin client server 30 can activate a virtual machine corresponding to an account used for login in accordance with a login request from the thin client terminal 3. The “account” described herein indicates identification information and authentication information on a user. For example, a user identifier (ID) may be used as the identification information on the user. Furthermore, a password, biological information, or the like may be used as the authentication information. When the virtual machine is activated as described above, the thin client server 30 applies, to the virtual machine, a policy, such as access authority, on the security given to the account.

The policy management server 100 is a server device that manages a policy to be applied to the virtual machine that operates on the thin client server 30. The “policy management server” described herein corresponds to an example of the policy management device.

As one embodiment, the policy management server 100 performs a process as described below every time the thin client terminal 3 sends a login request to the thin client server 30. Specifically, the policy management server 100 acquires, from the thin client server 30, address information, for example, a network address NW such as an IP address or a MAC address, on the thin client terminal 3 that sends the login request. At the same time or at a timing around this time, the policy management server 100 acquires, from the thin client server 30, a policy being applied to a virtual machine assigned to an account used for the login request. Then, if a policy that defines application to an environment corresponding to the network address NW and the policy currently applied to the virtual machine are different, the policy management server 100 transmits, to the thin client server 30, the policy that defines application to an environment corresponding to the network address NW. Consequently, setting of the policy applied to the virtual machine is changed in accordance with a change in the environment in which the thin client terminal 3 connects to the thin client server 30.

Configuration of the Thin Client Server 30

A functional configuration of the thin client server 30 according to the first embodiment will be described below. As illustrated in FIG. 1, the thin client server 30 includes an applied policy storage unit 31 and a virtual machine executing unit 32. The thin client server 30 may include various functional units included in a known computer, for example, functional units such as various input devices or voice output devices, in addition to the processing units illustrated in FIG. 1.

The applied policy storage unit 31 is a storage unit that stores therein a policy to be applied to the virtual machine. Examples of the “policy” described herein include a policy on security.

As one embodiment, the applied policy storage unit 31 stores therein information for specifying a policy to be applied to a virtual machine assigned to an account or a group of accounts, for each account or each group. For example, the applied policy storage unit 31 may be implemented by employing a user store provided by a directory service for a thin client, and by setting, for an account or a group of accounts included in the user store, a policy to be applied to the virtual machine. In the following, the information for specifying a policy may be described as “policy specification information”. Herein, as one example, a case will be described in which the policy specification information is stored in the applied policy storage unit 31; however, a setting file of a policy to be applied to the virtual machine may be stored as it is. Furthermore, the applied policy storage unit 31 may store therein the policy specification information for each identification information on a virtual machine assigned to an account.

The virtual machine executing unit 32 is a processing unit that executes a virtual machine.

As one embodiment, the virtual machine executing unit 32 accepts a connection request from the thin client terminal 3. The “connection request” described herein includes, as one example, a new connection request for newly accepting a login request form the thin client terminal 3 while a virtual machine is not activated. The above-described “connection request” includes a reconnection request, in addition to the new connection request. For example, if a network used by the thin client terminal 3 to access the thin client server 30 is changed because the thin client terminal 3 is carried around for example, the thin client terminal 3 sends a reconnection request to the thin client server 30 in order to establish a communication connection again. Furthermore, when the thin client terminal 3 shifts to a sleep state because of a no-operation state or screen lock, the thin client terminal 3 may send a reconnection request to the thin client server 30. When the thin client terminal 3 sends a reconnection request to the thin client server 30 as described above, it may be possible to send a communication connection establishment request, or to send a re-login request together with the communication connection establishment request.

For example, when accepting a login request from the thin client terminal 3, the virtual machine executing unit 32 starts to activate a virtual machine assigned to an account with which the login request is sent, on condition that login authentication for the account that has sent the login request is permitted. Specifically, the virtual machine executing unit 32 is assigned with a resource by a virtual OS, such as a hypervisor, that operates on the thin client server 30 from a resource pool in which resources, such as a central processing unit (CPU), a memory, a storage, and a network, are logically pooled. Then, the virtual machine executing unit 32 generates a disk image of the virtual machine in accordance with the policy stored in the applied policy storage unit 31, and activates the virtual machine. If the virtual machine is activated as described above, the virtual machine executing unit 32 causes an agent executing unit 320 to execute an agent program, thereby activating, on the virtual machine, an agent that monitors an environment in which the thin client terminal 3 connects to the thin client server 30.

The agent executing unit 320 is a processing unit that executes the above-described agent.

The agent executing unit 320 virtually implements processing units as described below by executing the agent on the virtual machine. For example, as illustrated in FIG. 1, the agent executing unit 320 includes an acquiring unit 321, a transmitting unit 322, a lock control unit 323, and a logout executing unit 324.

The acquiring unit 321 is a processing unit that acquires, from a virtual machine, address information on the thin client terminal 3 that sends a connection request for the virtual machine.

As one embodiment, if the agent is activated on the virtual machine, the acquiring unit 321 acquires a network address NW of the thin client terminal 3 that has sent a login request. Then, the acquiring unit 321 stores the network address NW1 in a work area of a memory on a virtual machine used by the agent. Subsequently, the agent that operates on the virtual machine sends a query to the virtual machine every time a reconnection request for the virtual machine is accepted from the thin client terminal 3, and the acquiring unit 321 acquires a network address NW2 of the thin client terminal 3 that has sent the reconnection request. Then, the acquiring unit 321 determines whether the network address NW1 stored in the work area of the memory on the virtual machine and the network address NW2 of the thin client terminal 3 that has sent the reconnection request match each other. After the determination, the acquiring unit 321 stores, as the network address NW1, the network address NW2 of the thin client terminal 3 that has sent the reconnection request in the work area of the memory on the virtual machine in an overwriting manner.

The transmitting unit 322 is a processing unit that transmits various kinds of information to the policy management server 100.

As one embodiment, if the network address NW1 stored in the work area of the memory on the virtual machine and the network address NW2 of the thin client terminal 3 that has sent the reconnection request do not match each other, the transmitting unit 322 transmits information as described below. For example, the transmitting unit 322 transmits, to the policy management server 100, the network address NW2 of the thin client terminal 3 that has sent the reconnection request and identification information on the virtual machine for which the thin client terminal 3 has requested reconnection or an account to which the virtual machine is assigned. In addition, the transmitting unit 322 may further transmit policy specification information stored in the applied policy storage unit 31, that is, information for specifying a policy being applied to the virtual machine. Meanwhile, if the network address NW1 and the network address NW2 match each other, the transmitting unit 322 may omit notification of the information.

The lock control unit 323 is a processing unit that performs lock control on an access from the thin client terminal 3 to the virtual machine.

As one embodiment, if the network address NW1 stored in the work area of the memory on the virtual machine and the network address NW2 of the thin client terminal 3 that has sent the reconnection request do not match each other, the lock control unit 323 restricts an access from the thin client terminal 3 to the virtual machine. For example, the agent gives an instruction on lock to a guest OS executed on the virtual machine, so that an access to a virtual desktop provided by the virtual machine is prohibited until the policy management server 100 gives permission. Subsequently, if the lock control unit 323 receives an instruction on release of lock from the policy management server 100, the agent gives an instruction on release of lock to the guest OS executed on the virtual machine, so that the lock of the access from the thin client terminal 3 to the virtual machine is released. In this case, an access to the virtual desktop provided by the virtual machine is allowed.

The logout executing unit 324 is a processing unit that executes logout.

As one embodiment, the logout executing unit 324 performs logout from the virtual machine in accordance with a logout instruction from the policy management server 100. For example, the logout executing unit 324 sends the logout instruction sent from the policy management server 100 to the guest OS executed on the virtual machine. Consequently, logout from the virtual machine is performed and the virtual machine enters a standby state to wait for re-login or shutdown.

Configuration of the Policy Management Server 100

A functional configuration of the policy management server 100 according to the first embodiment will be described below. As illustrated in FIG. 1, the policy management server 100 includes an acquiring unit 110, an environment definition storage unit 120, a change determining unit 130, a lock releasing unit 140, and a transmitting unit 150. The policy management server 100 may include various functional units included in a known computer, for example, functional units such as various input devices or voice output devices, in addition to the processing units illustrated in FIG. 1.

The acquiring unit 110 is a processing unit that acquires various kinds of information from the thin client server 30.

As one embodiment, the acquiring unit 110 acquires, from the agent executed on the virtual machine, in particular, from the transmitting unit 322 in the example of the processing units illustrated in FIG. 1, the network address NW2 of the thin client terminal 3 that has sent the reconnection request and identification information on the virtual machine for which the thin client terminal 3 has requested reconnection or an account to which the virtual machine is assigned. When notified of a change in the network for accessing the virtual machine from the thin client terminal 3 by the agent, the acquiring unit 110 sends a query about a policy being applied to the virtual machine to a component, such as a directory service, that operates on the thin client server 30. Consequently, the acquiring unit 110 further acquires the policy specification information stored in the applied policy storage unit 31 of the thin client server 30. While an example is described in which the policy being applied to the virtual machine is acquired via the directory service, it may be possible to acquire the policy being applied to the virtual machine from the agent.

The environment definition storage unit 120 is a storage unit that stores therein environment definition data that defines a policy to be applied to a virtual machine used by the thin client terminal 3 in an environment in which the thin client terminal 3 connects to the thin client server 30. The “environment definition data” described herein corresponds to an example of correspondence relation information on information on a policy corresponding to the address information.

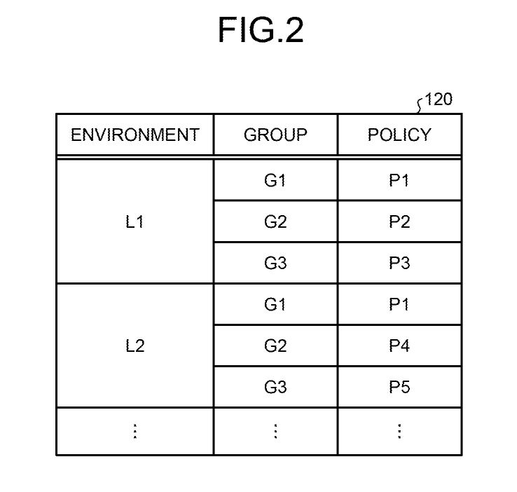

As one embodiment, as the above-described environment definition data, it may be possible to use data including an “environment” in which the thin client terminal 3 connects to the thin client server 30, a “group” into which an account is grouped, and a “policy”, all of which are associated with one another. FIG. 2 is a diagram illustrating an example of the environment definition data. In FIG. 2, for convenience of explanation, data in a table format is illustrated; however, data described in a tag format with a markup language, such as an Extensible Markup Language (XML) may be used. As one example, objects generated by a directory service may be used as the items such as the “environment”, the “group”, and the “policy” illustrated in FIG. 2. Each of the objects may be stored in a different area (not illustrated) by using information linked to the object as a property.

For example, as for the “environment”, a unit for providing different kinds of access authority to accounts of the same user or groups of accounts is set, in particular, an item of a place, such as a site of an organization, that can be classified by inside or outside the office is set. In the object of the environment, a network address, such as an IP address “192.168._0._1” to an IP address “192.168._0._99”, classified in the same environment is linked as a property. Furthermore, as for the “group”, an item of a group, such as the same branch or the same department, for combining users to whom the same policy is applied is set. In the object of the group, an object of each of the users included in the group is linked, and the object of each of the users is linked to an account of each of the users as a property. Moreover, as for the “policy”, access authority for a resource through the virtual machine is provided. For example, in the “environment” indicating the inside of the office, a policy of allowing reference of a file and output of a file, such as output to an external storage medium or output by printing, is set, while in the “environment” indicating the outside of the office, a policy of not allowing all of reference of a file and output of a file, such as output to an external storage medium or output by printing, is set. Needless to say, setting of the above-described policy may be changed depending on a group even in the same environment.

As one example, FIG. 2 illustrates a case in which policies for an in-office environment “L1” and an out-of-office environment “L2” are defined for each of groups “G1” to “G3”. For example, as for the groups “G2” and “G3” among the groups “G1” to “G3”, it is defined that different policies are applied between the in-office environment “L1” and the out-of-office environment “L2”. For example, as for the group “G2”, a policy “P2” is set for the in-office environment “L1” and a policy “P4” is set for the out-of-office environment “L2”. Furthermore, as for the group “G3”, a policy “P3” is set for the in-office environment “L1” and a policy “P5” is set for the out-of-office environment “L2”. By defining the policies in accordance with the environments, it is possible to appropriately change the policy to be applied depending on which of an in-office network and an out-of-office network is used by users belonging to the group “G2” and “G3” to access the thin client server 30.

The change determining unit 130 is a processing unit that determines whether a policy to be applied to a virtual machine is changed.

As one embodiment, the change determining unit 130 refers to the property linked to the object of the environment included in the environment definition data stored in the environment definition storage unit 120. Then, the change determining unit 130 specifies, among the environments included in the environment definition data, an environment corresponding to the network address of the thin client terminal 3 that has sent the reconnection request, where the network address is acquired by the acquiring unit 110. Furthermore, the change determining unit 130 refers to the property linked to the object of the group included in the environment definition data. Then, the change determining unit 130 further specifies, among the groups included in the environment definition data, a group corresponding to the identification information on the virtual machine or the account to which the virtual machine is assigned, where the identification information or the account is acquired by the acquiring unit 110. Subsequently, the change determining unit 130 specifies policy specification information associated with the specified environment and the specified group among the policies included in the environment definition data. Then, the change determining unit 130 determines whether the policy specification information specified from the environment definition data matches the policy specification information that is acquired by the acquiring unit 110 and that is being applied to the virtual machine.

The lock releasing unit 140 is a processing unit that releases lock of the virtual machine.

As one embodiment, if the policy specification information specified from the environment definition data matches the policy specification information that is acquired by the acquiring unit 110 and that is being applied to the virtual machine, the lock releasing unit 140 performs a process as described below. Specifically, the lock releasing unit 140 transmits an instruction to release lock of the virtual machine to an agent that operates on a virtual machine that has sent a notice to the acquiring unit 110 among virtual machines that operate on the thin client server 30. If the two pieces of the above-described policy specification information match each other, it is found that a policy suitable for the environment in which the thin client terminal 3 connects to the thin client server 30 is already set in the applied policy storage unit 31. In this case, the lock of the virtual desktop provided by the the virtual machine is released.

The transmitting unit 150 is a processing unit that transmits various kinds of information to the thin client server 30.

As one embodiment, if the policy specification information specified from the environment definition data does not match the policy specification information that is acquired by the acquiring unit 110 and that is being applied to the virtual machine, the transmitting unit 150 performs a process as described below. Specifically, the transmitting unit 150 refers to the correspondence relation information, such as the environment definition data, which is stored in the storage unit with respect to information on a user account transmitted from the thin client server 30 and which is about information on a policy corresponding to address information, thereby specifying information on a policy corresponding to the received address information, such as the network address and selecting a policy corresponding to the specified information on the policy as a policy to be applied to the virtual machine. Subsequently, the transmitting unit 150 transmits the policy specification information specified from the environment definition data to a component, such as a directory service, that operates on the thin client server 30. Consequently, the policy specification information corresponding to the virtual machine that has sent the notice to the acquiring unit 110 among the policies stored in the applied policy storage unit 31 is updated and overwritten with the policy specification information transmitted by the transmitting unit 150. Furthermore, the transmitting unit 150 transmits, to the agent that operates on the virtual machine that has sent the notice to the acquiring unit 110 among the virtual machines that operate on the thin client server 30, a logout instruction to release a login state of the account. Consequently, it becomes possible to perform re-login to a virtual machine in accordance with the policy updated and overwritten in the applied policy storage unit 31.

Incidentally, the above-described processing units, such as the acquiring unit 110, the change determining unit 130, the lock releasing unit 140, and the transmitting unit 150, may be implemented as described below. For example, the processing units are implemented by causing a central processor, such as a so-called CPU, to load a process for implementing the same functions as those of the above-described processing units on a memory and to execute the process. The processing units need not necessarily be executed by the central processor, and may be executed by a micro processing unit (MPU). Furthermore, each of the above-described functional units may be implemented by hard wired logic, such as an application specific integrated circuit ASIC) or a field programmable gate array (FPGA).

Moreover, as the above-described environment definition storage unit 120, as one example, various semiconductor memory elements, such as a random access memory (RAM) or a flash memory, may be used. Furthermore, the above-described environment definition storage unit 120 need not necessarily be implemented as a main storage device, and may be implemented as an auxiliary storage device. In this case, a hard disk drive (HDD), an optical disk, a solid state drive (SSD), or the like may be used.

Flows of Processes

The flows of processes performed by the virtual machine control system according to the first embodiment will be described below. In the following, (1) a login process, (2) a policy changing process, and (3) a change determination process will be described in this order.

1. Login Process

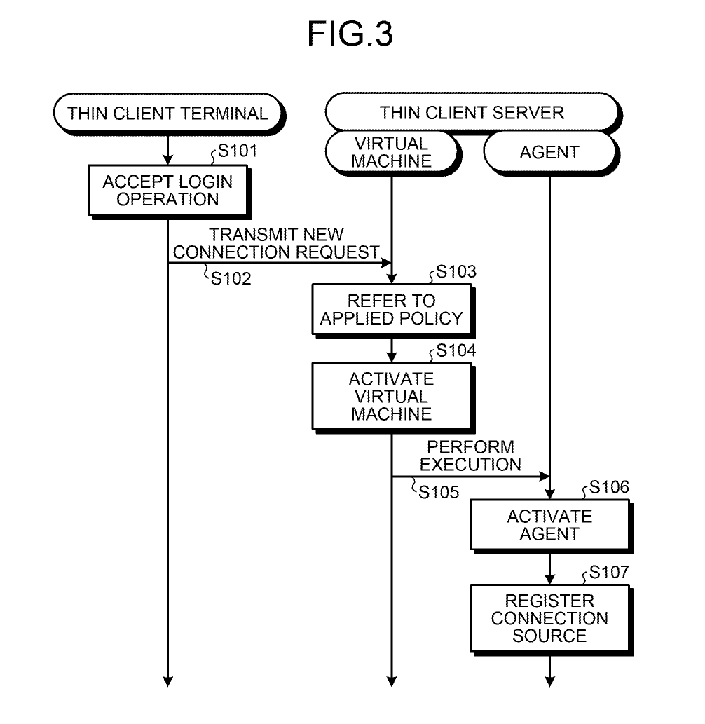

FIG. 3 is a sequence diagram illustrating the flow of the login process according to the first embodiment. As one example, FIG. 3 illustrates a sequence of a process performed after the thin client terminal 3 accepts login operation and before a service of a virtual desktop, such as transmission of operation information by the thin client terminal 3 or transmission of screen information by the thin client server 30, is started.

As illustrated in FIG. 3, the thin client terminal 3 accepts login operation of inputting a user ID, a password, or the like via an input device (not illustrated) (Step S101). Subsequently, the thin client terminal 3 transmits the login information accepted at Step S101 and the network address of the thin client terminal 3, to thereby transmit a new connection request for a virtual machine, that is, a login request, to the thin client server 30 (Step S102).

In response to the request, the virtual machine executing unit 32 starts to activate the virtual machine assigned to the account, on condition that login authentication for the account that has sent the login request is permitted. Specifically, the virtual machine executing unit 32 is assigned with a resource by a virtual OS, such as a hypervisor, that operates on the thin client server 30, generates a disk image of the virtual machine in accordance with the policy stored in the applied policy storage unit 31, and activates the virtual machine (Step S103 and Step S104). Consequently, the virtual machine in which the policy stored in the applied policy storage unit 31 is set operates on the thin client server 30.

After the virtual machine is activated as described above, the virtual machine executing unit 32 notifies the agent executing unit 320 of an instruction to execute the agent program (Step S105). The agent executing unit 320 executes the above-described agent program on the virtual machine in accordance with the instruction, thereby activating the virtual machine (Step S106). Then, the acquiring unit 321 stores the network address NW1 of the thin client terminal 3 that has sent the login request in a work area of a memory on the virtual machine used by the agent (Step S107).

After execution of the process at Step S107, the service of the virtual desktop, such as transmission of operation information by the thin client terminal 3 or transmission of screen information by the thin client server 30, is started.

2. Policy Changing Process

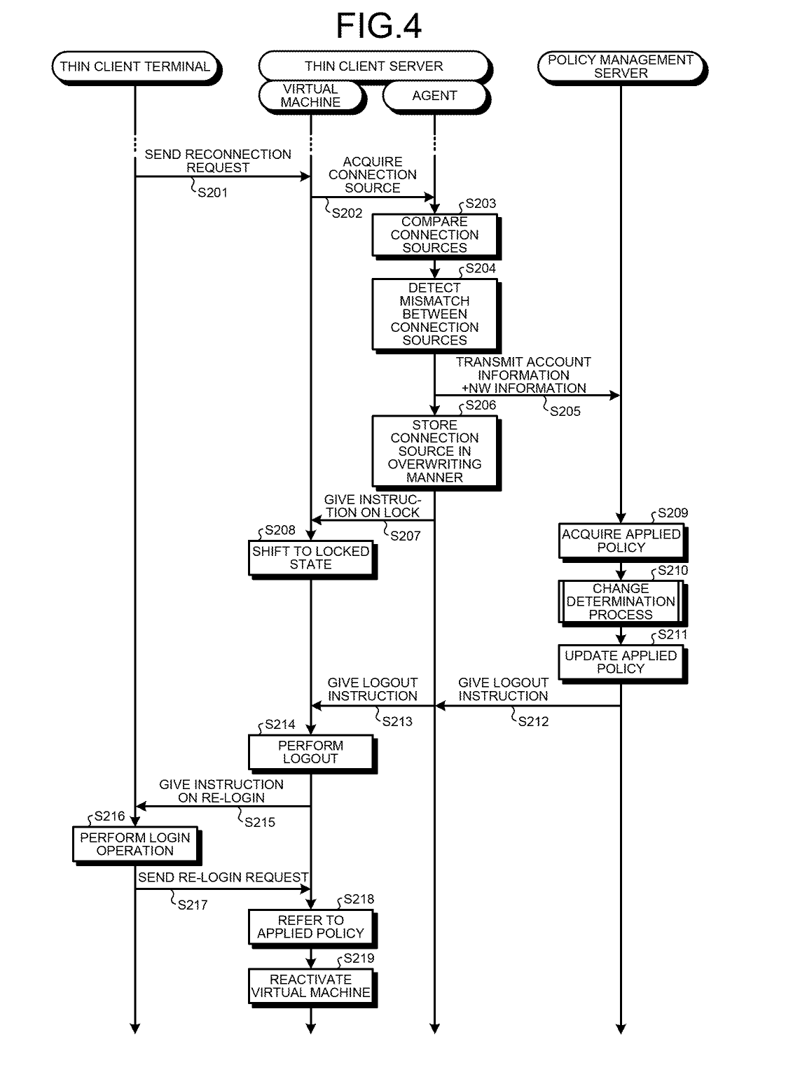

FIG. 4 is a sequence diagram illustrating the flow of the policy changing process according to the first embodiment. As one example, FIG. 4 illustrates a sequence in which the policy management server 100 is notified of a network address that is changed with a change in the network that the thin client terminal 3 uses to access the thin client server 30, and in which setting of a policy applied to the virtual machine is changed.

As described above, if the network used by the thin client terminal 3 to access the thin client server 30 is changed, as illustrated in FIG. 4, the thin client terminal 3 sends a reconnection request for a virtual machine to the thin client server 30 (Step S201). In this case, it may be possible to send only the reconnection request, or send the reconnection request and a re-login request.

In response to the request, the agent that operates on the virtual machine sends a query to the virtual machine, so that the acquiring unit 321 acquires the network address NW2 of the thin client terminal 3 that has sent the reconnection request (Step S202).

Then, the acquiring unit 321 compares the network address NW1 stored in the work area of the memory on the virtual machine and the network address NW2 of the thin client terminal 3 that has sent the reconnection request (Step S203).

As a result of the comparison at Step S203, if mismatch between the network address NW1 and the network address NW2 is detected (Step S204), the transmitting unit 322 performs a process as described below.

Specifically, the transmitting unit 322 transmits, to the policy management server 100, one of identification information on the virtual machine for which the thin client terminal 3 has request reconnection and an account to which the virtual machine is assigned, and the network address NW2 of the thin client terminal 3 that has sent the reconnection request (Step S205). If the network address is transmitted to the policy management server 100 as described above, the acquiring unit 321 stores, as the network address NW1, the network address NW2 of the thin client terminal 3 that has sent the reconnection request in the work area of the memory on the virtual machine in an overwriting manner (Step S206).

Meanwhile, in parallel to the processes at Step S205 and Step S206, the lock control unit 323 gives an instruction on lock of the virtual machine to the guest OS executed on the virtual machine (Step S207). The virtual machine shifts to a locked state in which an access to the virtual desktop provided by the virtual machine is prohibited, in accordance with the instruction given at Step S207 (Step S208).

Furthermore, after the policy management server 100 acquires the account and the network address as a result of the process at Step S205, the acquiring unit 110 of the policy management server 100 sends a query about the policy being applied to the virtual machine to a component, such as a directory service, that operates on the thin client server 30, and further acquires the policy specification information stored in the applied policy storage unit 31 of the thin client server 30 (Step S209).

Subsequently, the change determining unit 130 performs the “change determination process” of determining whether the policy applied to the virtual machine is changed (Step S210). As a result of the “change determination process”, if the policy applied to the virtual machine is changed, the transmitting unit 150 transmits the policy specification information specified from the environment definition data to a component, such as a directory service, that operates on the thin client server 30, so that the policy specification information stored in the applied policy storage unit 31 is updated and overwritten with the policy specification information transmitted by the transmitting unit 150 (Step S211).

In parallel to the process at Step S211, the transmitting unit 150 transmits a logout instruction to release the login state of the account to the agent that operates on the virtual machine that has sent the notice at Step S205 among virtual machines operating on the thin client server 30 (Step S212). Furthermore, the logout executing unit 324 of the agent executing unit 320 transfers the logout instruction notified at Step S212 to the guest OS executed on the virtual machine (Step S213).

The virtual machine executing unit 32 performs logout from the virtual machine in accordance with the logout instruction notified at Step S213 (Step S214), and instructs the thin client terminal 3 to perform re-login (Step S215).

Thereafter, the thin client terminal 3 accepts login operation of inputting a user ID, a password, or the like (Step S216). Subsequently, the thin client terminal 3 transmits the login information accepted at Step S216 and the network address of the thin client terminal 3, to thereby transmit a reconnection request for a virtual machine, that is, a re-login request, to the thin client server 30 (Step S217).

In response to the request, the virtual machine executing unit 32 starts to reactivate the virtual machine assigned to the account, on condition that login authentication for the account that has sent the re-login request is permitted. Specifically, the virtual machine executing unit 32 is assigned with a resource by a virtual OS, such as a hypervisor, that operates on the thin client server 30, generates a disk image of the virtual machine in accordance with the policy stored in the applied policy storage unit 31, and reactivates the virtual machine (Step S218 and Step S219).

After execution of the process at Step S219, the service of the virtual desktop, such as transmission of operation information by the thin client terminal 3 or transmission of screen information by the thin client server 30, is resumed.

(3) Change Determination Process

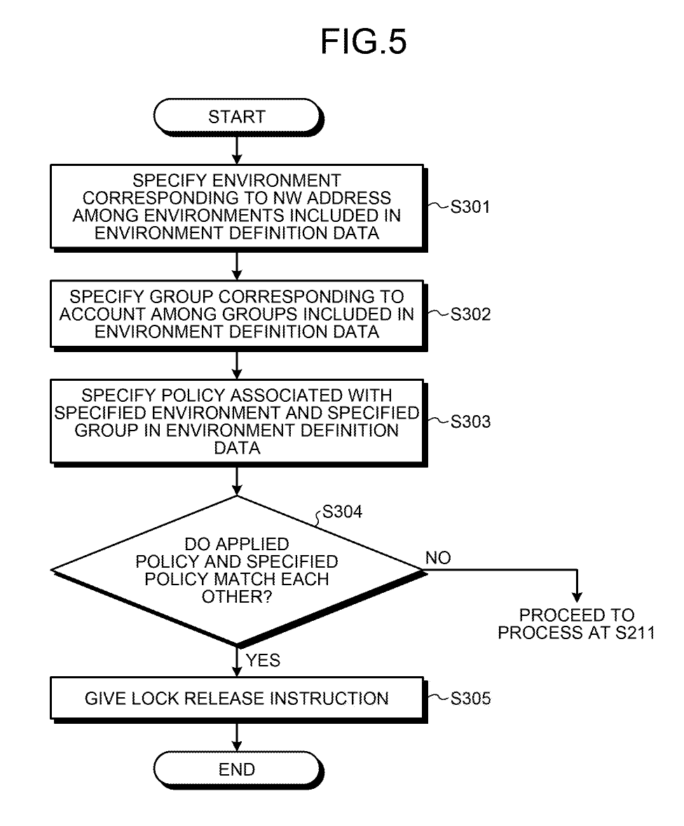

FIG. 5 is a flowchart illustrating the flow of the change determination process according to the first embodiment. This process corresponds to the process at Step S210 illustrated in FIG. 4, and is started after the process at Step S205 illustrated in FIG. 4 is executed.

As illustrated in FIG. 5, the change determining unit 130 refers to the property liked to the object of the environment included in the environment definition data, and specifies an environment corresponding to the network address of the thin client terminal 3 acquired at Step S205 among the environments included in the environment definition data (Step S301).

Furthermore, the change determining unit 130 refers to the property linked to the object of the group included in the environment definition data, and further specifies a group corresponding to the identification information on the virtual machine or the account to which the virtual machine is assigned, which is acquired at Step S205, among the groups included in the environment definition data (Step S302).

Thereafter, the change determining unit 130 specifies policy specification information associated with the environment specified at Step S301 and the group specified at Step S302 among the policies included in the environment definition data (Step S303).

Then, the change determining unit 130 determines whether the policy specification information specified from the environment definition data at Step S303 and the applied policy specification information acquired at Step S209 match each other (Step S304).

In this case, if the two pieces of the above-described policy specification information match each other (YES at Step S304), it is found that the policy suitable for the environment in which the thin client terminal 3 connects to the thin client server 30 is already set in the applied policy storage unit 31. In this case, the lock releasing unit 140 transmits a lock release instruction to the virtual machine operating on the thin client server 30 (Step S305), and the process ends.

In contrast, if the two pieces of the above-descried policy specification information do not match each other (NO at Step S304), the process proceeds to the process at Step S211 illustrated in FIG. 4, and the processes from Step S211 are performed.

Aspect of Effects

As described above, the virtual machine control system 1 according to the embodiment changes setting of a policy applied to a virtual machine that the thin client server 30 causes the thin client terminal 3 to use, in accordance with a change in a network environment in which the thin client terminal 3 connects to the thin client server 30. Therefore, for example, even when a file prohibited to be accessed outside the office is taken from the inside to the outside of the office while the file is loaded on the memory of the thin client terminal 3, the policy is changed from the in-office policy to the out-of-office policy in accordance with the action of taking the thin client terminal 3 from the inside to the outside of the office. Therefore, according to the virtual machine control system 1 of the first embodiment, it is possible to prevent reduction in the security.

Furthermore, in the virtual machine control system 1 according to the first embodiment, for example, it may be possible to provide the same user with a plurality of accounts for the inside and the outside of the office in order to implement a change in the policy as described above, and the thin client system need not be duplicated for the inside and the outside of the office. Therefore, according to the virtual machine control system 1 of the first embodiment, it is possible to reduce an initial cost of introduction of the system and a running cost of the system.

### [b] Second Embodiment

While the embodiment of the disclosed technology has been described above, the present invention may be embodied in various forms other than the above-described embodiment. The other embodiments of the disclosed technology will be described below.

Data Storage at the Time of Logout

In the above-described first embodiment, an example has been described in which logout from the virtual machine is performed when the policy applied to the virtual machine is changed. However, in this case, it may be possible to permit a part of operation on a file edited by an application program that operates on the virtual machine.

Specifically, when accepting a logout instruction from an agent, a guest OS that operates on the virtual machine determines whether a file that is loaded on a memory by an application program operating on the virtual machine is present. If the file is present, the guest OS determines whether there is a difference between the file before being executed by the application program and the file loaded on the memory by the application program, that is, determines whether edit is performed, in addition to referring to the file. Then, if there is a difference between the files, the guest OS performs, as one example, a process as described below. For example, the guest OS displays, on the thin client terminal 3, a window including two GUI components for an option to store the file in an overwriting manner and an option to perform logout without storing the file in an overwriting manner. Then, if the thin client terminal 3 selects the option to store the file in an overwriting manner, the guest OS stores the file that is loaded on the memory by the application program in an overwriting manner, and performs logout from the virtual machine. Consequently, it is possible to prevent deletion of data that is edited by the application program.

While an example has been described in which the file is stored in an overwriting manner, it may be possible to store the file as a different file by assigning it a name different from the name of the original file, or it may be possible to store the file in an overwriting manner or with a different name without performing confirmation operation from the thin client terminal 3.

### Other Application Examples

In the above-described first embodiment, an example has been described in which the thin client server 30 provides the virtual machine to the thin client terminal 3; however, the embodiment may be applied to a case in which at least one of computational resources, such as computation time (CPU), memory operation time, a secondary storage, and an input/output device, is provided instead of the virtual machine.

Distribution and Integration

The components illustrated in the drawings need not necessarily be physically configured in the manner illustrated in the drawings. That is, specific forms of distribution and integration of the devices are not limited to those illustrated in the drawings, and all or part of the devices may be functionally or physically distributed or integrated in arbitrary units depending on various loads or use conditions. For example, while an example has been illustrated in which the thin client server 30 and the policy management server 100 are implemented as different servers in the above-described virtual machine control system 1, they need not necessarily be implemented as two server devices in a distributed manner. That is, the thin client server 30 and the policy management server 100 may be integrated and implemented as a single server device.

Virtual Machine Control Program

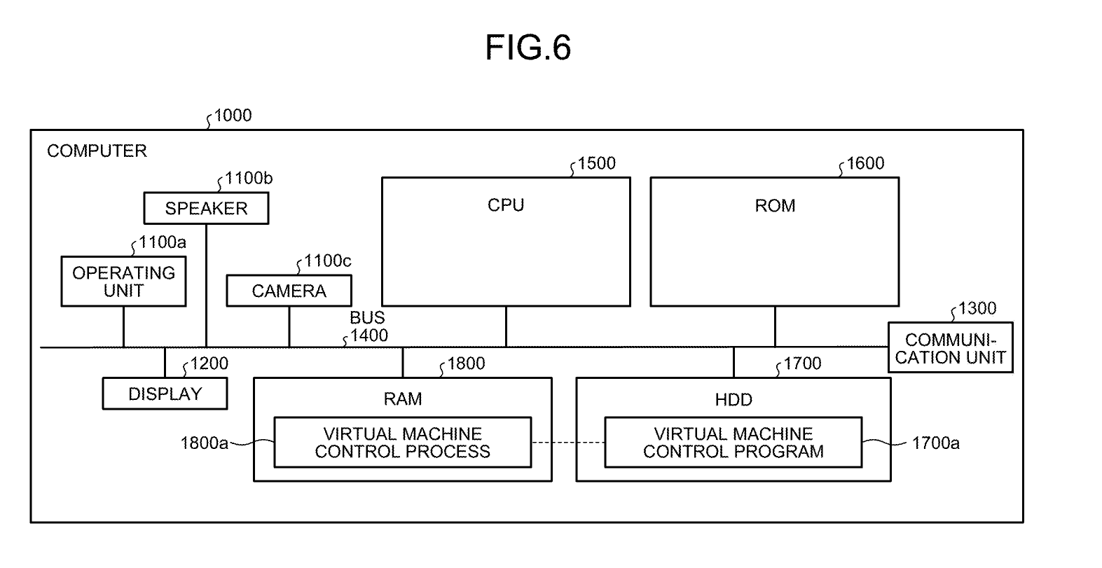

The various processes described in the above-described embodiments are implemented by causing a computer, such as a personal computer or a workstation, to execute a program prepared in advance. In the following, an example of a computer that executes a virtual machine control program with the same functions as those of the above-described embodiments will be described below with reference to FIG. 6.

FIG. 6 is a diagram illustrating a hardware configuration example that performs the virtual machine control program according to the first and the second embodiments. As illustrated in FIG. 6, a computer 1000 includes an operating unit 1100a, a speaker 1100b, a camera 1100c, a display 1200, and a communication unit 1300. Furthermore, the computer 1000 includes a CPU 1500, a ROM 1600, an HDD 1700, and a RAM 1800 The components 1100 to 1800 are connected to one another via a bus 1400.

As illustrated in FIG. 6, the HDD 1700 stores therein a virtual machine control program 1700a that implements the same functions as the acquiring unit 110, the change determining unit 130, the lock releasing unit 140, and the transmitting unit 150 of the above-described first embodiment. The virtual machine control program 1700a may be integrated or disintegrated, in the same manner as the components of the acquiring unit 110, the change determining unit 130, the lock releasing unit 140, and the transmitting unit 150 illustrated in FIG. 1. That is, the HDD 1700 need not necessarily store all pieces of data illustrated in the above-described first embodiment, and it is sufficient that data used for a process is stored in the HDD 1700.

In this environment, the CPU 1500 reads the virtual machine control program 1700a from the HDD 1700, and loads the program on the RAM 1800. Consequently, the virtual machine control program 1700a functions as a virtual machine control process 1800a as illustrated in FIG. 6. The virtual machine control process 1800a loads various kinds of data read from the HDD 1700 onto an area assigned for the virtual machine control process 1800a among storage areas included in the RAM 1800, and performs various processes by using various kinds of the loaded data. For example, examples of the processes performed by the virtual machine control process 1800a include the processes illustrated in FIG. 3 to FIG. 5. Meanwhile, in the CPU 1500, not all of the processing units explained in the above-described first embodiment need to operate, and it is sufficient that a processing unit corresponding to a process to be executed is virtually implemented.

The above-described virtual machine control program 1700a need not necessarily be stored in the HDD 1700 or the ROM 1600 from the beginning. For example, each of the programs may be stored in a “portable physical medium”, such as a flexible disk (so-called FD), a compact disk-ROM (CD-ROM), a digital versatile disk (DVD), a magneto optical disk, or an integrated circuit (IC) card, inserted in the computer 1000. Then, the computer 1000 may acquire each of the programs from the portable physical medium and execute the programs. Furthermore, it may be possible to store each of the programs in a different computer, a server device, or the like that is connected to the computer 1000 via a public line, the Internet, the LAN, or the WAN, and cause the computer 1000 to acquire the programs from the device and execute the programs.

It is possible to prevent reduction in the security.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A thin client system comprising:
a server device that provides a virtual machine to a thin client device in response to a request from the thin client device; and
a policy management device that manages information on a policy to be applied to the virtual machine, wherein
the server device includes a processor that executes a process including:
transmitting, upon accepting a login request for the virtual machine using a specific user account from the thin client device, information on the user account and address information on the thin client device to the policy management device, and
the policy management device includes a processor that executes a process including:
specifying information on a policy corresponding to the received address information by referring to correspondence relation information that is stored in a storage with respect to the transmitted information on the user account and that is about information on a policy corresponding to address information; and
selecting a policy corresponding to the specified information on the policy as a policy to be applied to the virtual machine.

2. The thin client system according to claim 1, wherein the process of the policy management device further comprises:
transmitting a request for logoff of the virtual machine to the server device, when the information on the policy stored in the storage is different from the acquired information on the policy.

3. The thin client system according to claim 1, wherein when the acquired address information is different from address information that has been acquired just before the acquired address information, the transmitting of the process of the server device includes transmitting the acquired address information to the policy management device.

4. The thin client system according to claim 2, wherein the process of the server device further comprises:
storing therein a file executed by an application program that operates on the virtual machine in a storage, upon accepting a request for logoff of the virtual machine from the policy management device.

5. The thin client system according to claim 4, wherein when there is a difference between the file executed by the application program that operates on the virtual machine and a file before being executed by the application program, the storing of the process of the server device includes storing therein the file executed by the application program that operates on the virtual machine in the storage.

6. The thin client system according to claim 4, wherein the storing of the process of the server device includes storing therein the file in an overwriting manner or storing therein the file independent of a file before being executed by the application program by assigning the file a name different from a name of the file.

7. A control method implemented by a thin client system including a server device that provides a virtual machine to a thin client device in response to a request from the thin client device, and including a policy management device that manages information on a policy to be applied to the virtual machine, the control method comprising:
transmitting, by the server device, upon accepting a login request for the virtual machine using a specific user account from the thin client device, information on the user account and address information on the thin client device to the policy management device;
specifying, by the policy management device, information on a policy corresponding to the received address information by referring to correspondence relation information that is stored in a storage with respect to the transmitted information on the user account and that is about information on a policy corresponding to address information; and
selecting a policy corresponding to the specified information on the policy as a policy to be applied to the virtual machine.

8. A non-transitory computer-readable recording medium having stored therein a control program that causes a server device of a thin client system to execute a process comprising:
transmitting, upon accepting a login request for the virtual machine using a specific user account from a thin client device, information on the user account and address information on the thin client device to a policy management device;
operating the virtual machine by applying a policy based on policy information provided by the policy management device in accordance with transmission of the information on the user account and the address information on the thin client device.

9. A control method implemented by a server device of a thin client system, the control method comprising:
transmitting, upon accepting a login request for a virtual machine using a specific user account from a thin client device, information on the user account and address information on the thin client device to a policy management device; and
operating the virtual machine by applying a policy based on policy information provided by the policy management device in accordance with transmission of the information on the user account and the address information on the thin client device.

10. A server device included in a thin client system, the server device comprising:
a processor that executes a process comprising:
transmitting, upon accepting a login request for a virtual machine using a specific user account from a thin client device, information on the user account and address information on the thin client device to a policy management device; and
operating the virtual machine by applying a policy based on policy information provided by the policy management device in accordance with transmission of the information on the user account and the address information on the thin client device.

11. A non-transitory computer-readable recording medium having stored therein a control program that causes a policy management device, which manages a policy to be applied to a virtual machine that operates in a thin client system, to execute a process comprising:
receiving, in response to a login request for the virtual machine using a specific user account from a thin client device, information on the user account and address information on the thin client device that are transmitted from a server device of the thin client system;
specifying information on a policy corresponding to the received address information by referring to correspondence relation information that is stored in a storage with respect to the received information on the user account and that is about information on a policy corresponding to address information; and
providing, to the server device, the specified information on the policy as information on a policy to be applied to the virtual machine.

12. A control method implemented by a policy management device that manages a policy to be applied to a virtual machine that operates in a thin client system, the control method comprising:
receiving, in response to a login request for the virtual machine using a specific user account from a thin client device, information on the user account and information on address information on the thin client device;
specifying information on a policy corresponding to the received address information by referring to correspondence relation information that is stored in a storage with respect to the received information on the user account and that is about information on a policy corresponding to address information; and
providing, to the server device, the specified information on the policy as information on a policy to be applied to the virtual machine.

13. A policy management device that manages a policy to be applied to a virtual machine that operates on a thin client system, the policy management device comprising:
a processor that executes a process comprising:
receiving, in response to a login request for the virtual machine using a specific user account from a thin client device, information on the user account and address information on the thin client device, the information and the address information being transmitted from a server device of the thin client system;
specifying information on a policy corresponding to the received address information by referring to correspondence relation information that is stored in a storage with respect to the received information on the user account and that is about information on a policy corresponding to address information; and
providing, to the server device, the specified information on the policy as information on a policy to be applied to the virtual machine.

14. A thin client system comprising:
a server device that provides a computational resource to a thin client device in response to a request from the thin client device; and
a policy management device that manages information on a policy to be applied to provide the computational resource, wherein
the server device includes a processor that executes a process including:
transmitting, upon accepting a request for the computational resource using a specific user account from the thin client device, information on the user account and address information on the thin client device to the policy management device, and
the policy management device includes a processor that executes a process including:
specifying information on a policy corresponding to the received address information by referring to correspondence relation information that is stored in a storage with respect to the transmitted information on the user account and that is about information on a policy corresponding to address information; and
selecting a policy corresponding to the specified information on the policy as a policy to be applied to provide the computational resource.
